(19) United States
(12) Patent Application Publication
(10) Pub. No.: US 2004/0122846 A1
(43) Pub. Date: Jun. 24, 2004

(54) Fact verification system

(75) Inventors: David M. Chess, Mohegan Lake, NY (US); Sophia Krasikov, Katonah, NY (US); John F. Morar, Mahopac, NY (US); Alla Segal, Mount Kisco, NY (US)

Correspondence Address: FERENCE & ASSOCIATES, 400 BROAD STREET, PITTSBURGH, PA, 15143, US

(73) Assignee: IBM Corporation, Armonk, NY

(21) Appl. No.: 10/324,723

(22) Filed: Dec. 19, 2002

(51) Int. Cl. G06F 17/00

(52) U.S. Cl. 707/102

(57) ABSTRACT

A system for providing fact verification for a body of text. The system includes either or both of: a fact-identification arrangement which automatically identifies at least one subset of the body of text potentially containing a fact-based statement; and a fact-verification arrangement which is adapted to automatically consult at least one information source towards determining whether at least one fact contained in a fact-based statement is true or false.

### FIELD OF THE INVENTION

The present invention relates generally to fact-checking in a wide variety of fields where written material is produced.

### BACKGROUND OF THE INVENTION

In the fields of journalism, writing, business and law it is often necessary to ensure that, in any of a wide range of written materials, written factual information is correct. The failure to verify factual information may yield undesirable results, ranging from, e.g., numerous corrections in newspapers to more serious problems such as loss of profits or the onset of legal actions. For example, a mistake committed with a company's name in a sentence such as “company ABC declares bankruptcy” may cause a significant drop in the incorrectly named company's stock value.

Currently, conventional fact-checking services are performed by and large manually either onsite or as work contracted out to a company providing such a service. Both of these methods are expensive, time-consuming and of course subject to human error. Because of these practical disadvantages, many businesses and even media companies can often do little or no fact-checking.

However, in view of the widely recognized importance of exemplary fact-checking, a need has been recognized in connection with the performance of such tasks in a more cost-effective and efficient manner.

### SUMMARY OF THE INVENTION

In accordance with at least one presently preferred embodiment of the present invention, there is broadly contemplated a system that automatically verifies facts presented in a text. The system can be built as a stand-alone marketable software product, an addition to a text editor or other text-processing system, or as a service such as a web-based service.

In summary, one aspect of the invention provides a system for providing fact verification for a body of text, the system comprising at least one of: a fact-identification arrangement which automatically identifies at least one subset of the body of text potentially containing a fact-based statement; and a fact-verification arrangement which is adapted to automatically consult at least one information source towards determining whether at least one fact contained in a fact-based statement is true or false.

A further aspect of the present invention provides a method for deploying computing infrastructure, comprising integrating computer readable code into a computing system, wherein the code in combination with the computing system is capable of performing a method of providing fact verification for a body of text, comprising at least one of the following: automatically identifying at least one subset of the body of text potentially containing a fact-based statement; and automatically consulting at least one information source towards determining whether at least one fact contained in a fact-based statement is true or false.

Furthermore, an additional aspect of the present invention provides a program storage device readable by machine, tangibly embodying a program of instructions executable by the machine to perform method steps for providing fact verification for a body of text, the method comprising at least one of the following steps: automatically identifying at least one subset of the body of text potentially containing a fact-based statement; and automatically consulting at least one information source towards determining whether at least one fact contained in a fact-based statement is true or false.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 depicts an overall verification of facts service 101 FIG. 2 is a flow diagram depicting operation of a retrieval and identification processor.

FIG. 3 is a flow diagram depicting operation of a source locator.

FIG. 4 is a flow diagram depicting operation of an origin-source verification processor.

FIG. 5 is a diagram depicting operation of a verification of facts portal.

### DESCRIPTION OF THE PREFERRED EMBODIMENTS

In accordance with a preferred embodiment of the present invention, there is broadly contemplated the use of a text analysis system that parses a text and identifies sentences and expressions that may constitute a reference to a given fact. For instance, the types of sentences and expressions identified may be along the lines of “XYZ Co. announces its earnings on January 10th” or “John Smith, head of the ABC fire department” or “Elizabeth I was a queen of England”. Such a text analysis system may also preferably be adapted to identify text containing a fact that can be verified with particular ease, such as a weekday-date combination (e.g., “Monday, January 21st, 1405”).

Once information is identified that can potentially be subject to automatic fact-checking, an attempt is then preferably made to verify the information. The results of the verification could then be presented to the writer or reviewer in essentially any conceivable user-friendly display format. In at least one embodiment of the present invention, the verification attempt could be conducted by automatically searching one or more sites on the World Wide Web; alternatively, one or more proprietary or for-fee databases could be automatically consulted.

By and large, a system embodied in accordance with at least one embodiment of the present invention will essentially be configured for providing assistance to a writer or reviewer and not to completely displace the human element of fact-checking. It should be appreciated, though, that in some cases the system may be able to both identify and verify facts, while in others may point out the facts that need verification, and yet in others may provide an indication that a particular sentence or expression may refer to a fact while leaving a final judgement to a human user.

Preferably, a system developed in accordance with at least one embodiment of the present invention will include at least three major components: a fact identification component, a verification component and a result presentation component.

The fact identification component will preferably be adapted to identify those subsets of text that are likely to represent assertions of fact, by using, e.g., methods of natural language processing and the information extraction as known in the art. It should be understood that essentially any currently existing methods that would be suitable can be customized to satisfy the intended purposes of this system.

For example, relevant language-processing technologies are described in: U.S. Pat. No. 5,369,575, “Constrained natural language interface for a computer system”; U.S. Pat. No. 6,081,774, “Natural language information retrieval system and method” (to de Hita), in which language based database queries are discussed; U.S. Pat. No. 4,914,590, “Natural language understanding system” (to Loatman et al); U.S. Pat. No. 6,327,593, “Automated system and method for capturing and managing user knowledge within a search system” (to Goiffon); U.S. Pat. No. 5,787,234, “System and method for representing and retrieving knowledge in an adaptive cognitive network”, in which searching and retrieving concepts are discussed, though the method can be applied to extracting facts. The subject of text mining and information retrieval is also discussed in the following IBM White Papers: “Text Mining Technology, Turning Information Into Knowledge”, D. Tkach, ed., Feb. 7, 1998, [http://www3.]ibm.com/software/data/iminer/fortext/download/whiteweb.pdf; and “Intelligence Text Mining Creates Business Intelligence” by Amy D. Wohl, Wohl Associates, February 1998, [http://www-3.]ibm.com/software/data/iminer/fortext/download/amipap.pdf. Some examples of automated tools for information retrieval include TextAnalysis, an automated tool for retrieval of information from Megaputer Intelligence, 120 West 7th Street, Suite 310, Bloomington, Ind. 47404, established in May of 1997, [http://www.]megaputer.com as well as “Project Gate”, which includes tools for information extraction, name and places identification and entity relationship recognition. (“Project Gate” is described in “Information Extraction—a User Guide (Second Edition)” by Hamish Cunningham, April 1999, Research memo CS-99-07, Institute for Language, Speech and Hearing [ILASH], and Department of Computer Science, University of Sheffield, England).

The fact identification component can preferably be broken down into several stages. In a first such stage, the sentences containing specific words or expressions can be marked. These words could be essentially anything indicative of an assertion of fact, and thus “attractive” to the fact-identification component, such as: names of people or companies, dates, weekday names, subject-specific keywords (such as “bankruptcy” or “profits”), names of diseases, quotations, titles, addresses, zip codes, telephone numbers, or the name of geographical places. Though many possible arrangements exist to enable a fact-identification component to identify such items, a particularly simple arrangement would involve a string-search for specific words or expressions; this can be undertaken using any of numerous string-matching algorithms known in the art. It would also be possible to use an information extraction tool, such as “Project Gate” mentioned above.

In a second stage, the interactions between words can preferably be considered. For example, is a person's name accompanied by a correct title? In such a case, the correspondence between the name and the title would need to be verified, such as through a web search or consultation of a for-fee or proprietary database. The correlation between consecutive sentences could be considered, as well. For example, “Dr Smith said. He is a president of company ABC.” As such, the system could preferably be adapted to recognize the following as facts subject to verification: that the “He” in the second sentence indeed refers to “Dr Smith”, that he indeed is a “Doctor”, that he indeed said what the article claims he did, and that Dr. Smith is indeed a president of company ABC.

During a third stage, an attempt is preferably made to remove those sentences or phrases identified as containing merely subjective information from a candidate list of facts. For example, sentences centering on subjectively descriptive adjectives like “beautiful” or “nice” are evaluated, and the sentences where a single “factual” word is accompanied only by such subjectively descriptive adjectives (or adjectives of “perception”) are removed from the candidate facts list. Thus, a hypothetical sentence such as, “Julia Smith is a beautiful woman” or “January 25th was a pleasant day” are preferably removed, while a sentence such as “Julia Smith, the well-known actress, is a beautiful woman” will preferably stay. However, in that case a modified sentence reading, e.g., “Julia Smith, the well-known actress” will be marked for verification so that subjectively descriptive adjectives will be avoided.

In a final stage, the list of facts will preferably be created. Each entry in the list will contain 1) the fact's location in the text and 2) two or three keywords identifying the fact (e.g., “Julia Smith—actress”).

More complex and sophisticated methods, including a system capable of learning, are also broadly contemplated in accordance with embodiments of the present invention. For instance, a neural network could be trained on a number of human marked-up examples, to learn how to distinguish with good probability between subjective and objective statements, and/or to identify types of sentences that need to be highlighted for verification.

A preferred embodiment of a verification component may encompass three major functions. The first one would be to locate the source of a specific fact; the second, to extract necessary or at least useful information from the source; and the third, to compare the extracted information with the fact-as stated in the text. The source location for verification is preferably determined based on the nature of a fact. If the fact refers to historical information (as identified, e.g., by a past date, historical context [e.g., the use of past tense plus references to, e.g., royalty, war or famine]) or terminology like “Middle Ages” or “Renaissance”, a potential source would be an on-line Encyclopedia such as “ENCARTA”. If, on the other hand, the fact refers to medical information (e.g., “the symptoms of anthrax are.”), the system could conceivably look up the CDC (Centers for Disease Control) web page or the on-line version of the Merck manual. In another example, facts relating to news could be verified by looking up CNN or Reuters pages. Other possible sources for verification might be on-line phone books or databases. In some cases, a search of several sources could potentially be done.

In accordance with at least one embodiment of the present invention, an organization could customize sources to suit its own needs. For instance, the system might come preconfigured with a list of most common sources, including, e.g., pages on the World Wide Web and common programs like Encarta or an on-line Thesaurus, and allow the user to customize the list by adding or modifying sources. In at least one embodiment of the present invention, the user could add customization in the form of one or more programs that would look up the information based on a string contained in the fact, or based on other properties such as the context in which the fact was found, the type of document it was found in, and perhaps other facts found in the same area. Also, the customization of sources could include the creation and maintenance of a database of known false statements.

After a source is found, the information about the fact is preferably extracted and compared to the information in the text being verified. The comparison may be done by any of a number of different methods, ranging from a simple comparison of groups of words and idioms to more complex currently existing natural language representation and processing methods that are currently used in machine translation or natural language query processing. For example, sentences could preferably be parsed and a tree representing their syntactical structure is constructed. Thereafter, the elements in certain key positions could be compared. The comparison may also reference a synonym database to ensure accuracy of the comparison.

In a preferred embodiment of the result presentation component, the information shown to the user could preferably be broken down into four groups: verified statements of fact, statements of fact that are probably false, statements of fact that the system could not verify, and possible statements of fact. The first group may contain statements that were verified and found to be correct. The second group could include statements that were found to be false; in accordance with a preferred embodiment of the present invention, correct information would actually be presented to the user either instead of or, for comparison purposes, in addition to the presentation of incorrect information (for comparison purposes. The third group could contain facts that the system was not able to either verify or construe as false (perhaps, e.g., because the required source information was not available). In accordance with at least one embodiment of the present invention, the system could recommend one or more possible sources for the information for the user to then obtain the information manually. The final group can contain those expressions or sentences that may contain facts, but for which the system could not with sufficient probability extract the statement for verification. For example, this might happen if for whatever reason an algorithm used to determine whether a fact “probably” exists yields “yes”, but if an algorithm for extracting the embedded fact actually fails.

The disclosure now turns to a practical example of an arrangement that may be used for fact-checking in accordance with at least one presently preferred embodiment of the present invention.

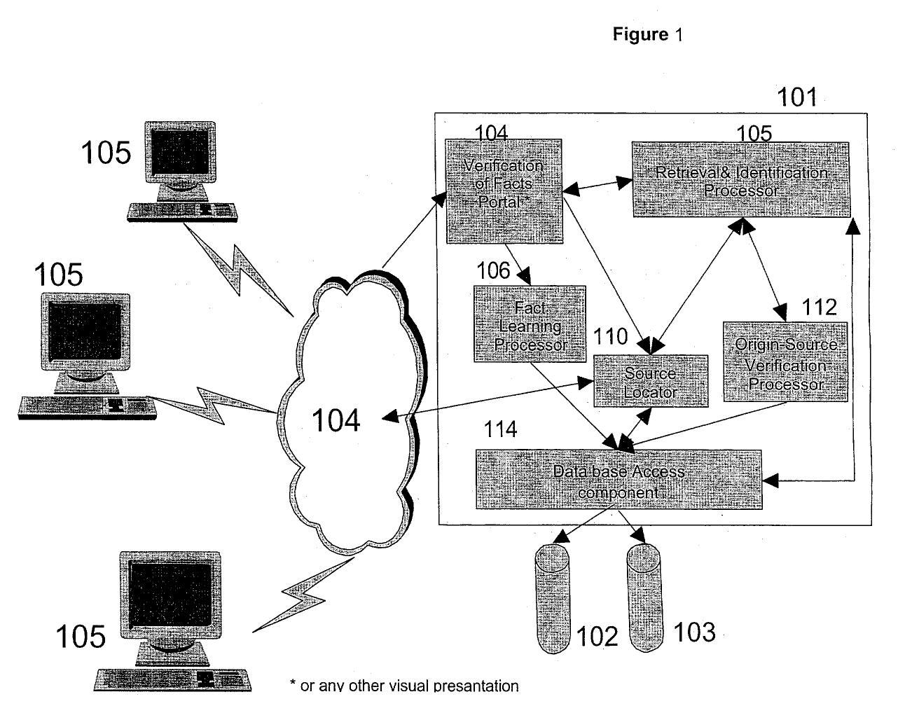

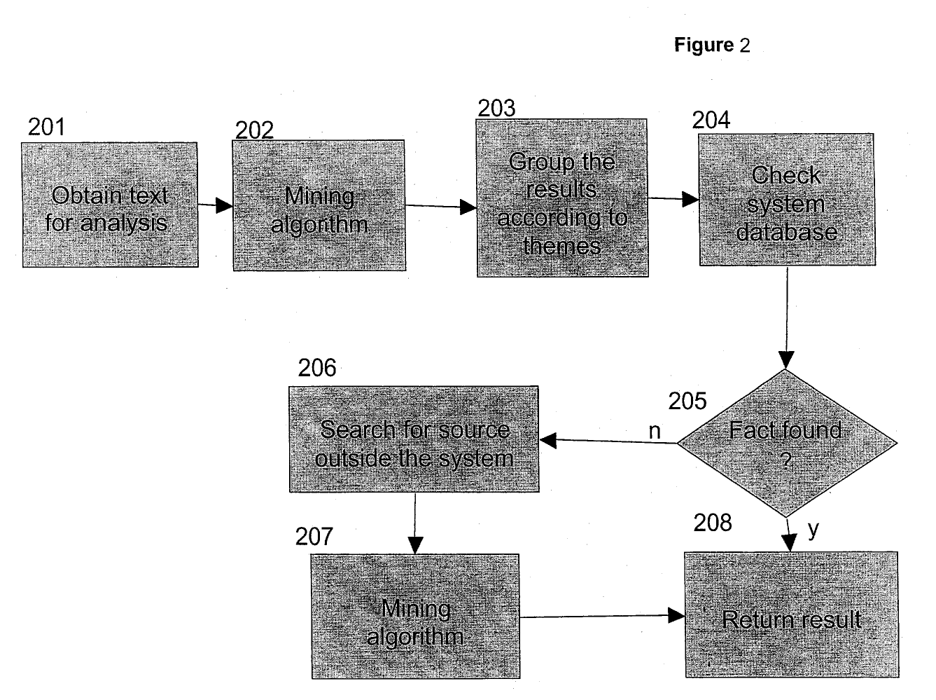

FIG. 1 shows a verification of facts service 101 which uses a system formed in accordance with a preferred embodiment of this invention. The service 101 communicates with customers 105 over a network 104 such as the global Internet. The service is implemented as a system comprising a “retrieval & identification” processor 105 which receives requests from “verification of facts” portal 104. In one embodiment, the request may come from a text editor or a text-processing system; thusly, a fact learning processor 106 could be included that provides customers with at least one simple function to add sources and facts in accordance with themes or subjects of interest to a customer, or to make corrections to previous decisions made by the system on facts and sources. In at least one embodiment, the fact learning processor 106 may include an adaptive algorithm that will utilize corrections made to improve its success rate. A source locator 110 is preferably provided that, after identifying a theme, checks the preconfigured list of themes and then executes a source search outside the system. Preferably, an origin-source verification processor 112 compares a fact from a given text to a fact found in a source. The verification processor 112 may utilize different comparison methods known in the art. Data base access component 114 may be provided to process incoming queries, and will preferably store and deliver preconfigured and accumulated facts and sources from or in a primary database 102 and possibly also a second database 103 that contains other relevant information such as system control information that includes business rules, data processing specifications, and domains for variables. Verification of facts portal 104 will preferably be configured to allow a customer to undertake many potentially useful functions, such as: submit requests for individual fact checking, submit requests to screen a document for facts, teach the system themes or subject areas, provide the system with theme-based facts, etc.

FIG. 2 is a flow diagram illustrating operation in accordance with a preferred embodiment of the present invention, particularly of a retrieval & identification processor (FIG. 1, 105). The processor is preferably configured for the retrieval and identification of facts from or in a submitted text document (201) or a found source (206). Retrieval and identification processor 106 may any of a number of different mining algorithms (202) well-known in the art. The found facts are preferably clustered or grouped in accordance with themes, or topics (203). The databases 102 and 103 (see FIG. 1) are preferably checked (204) before the system makes a decision (205) on whether to search for a source outside (206) via a mining algorithm (207). A found fact or clusters of facts yielded as results (208), from either an internal or external source, are preferably passed on later to the origin source processor (FIG. 1, 112) for comparison.

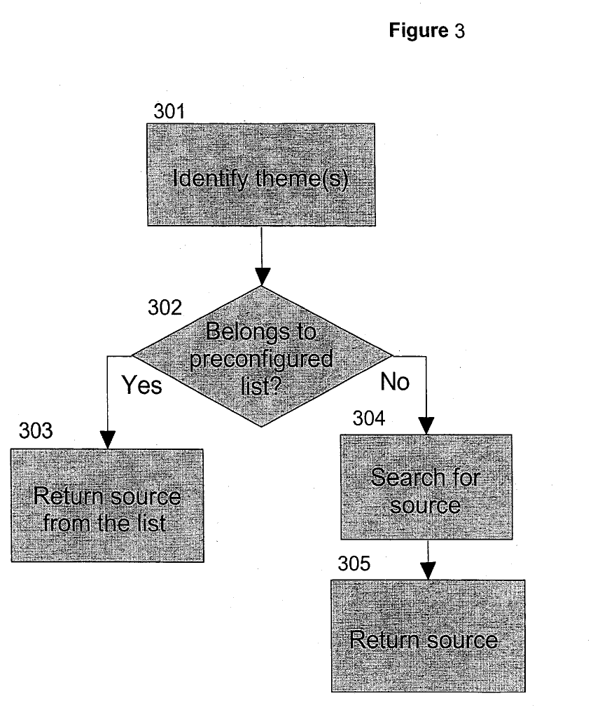

FIG. 3 is a flow diagram illustrating a further operational aspect in accordance with an embodiment of the present invention, particularly regarding the source locator (FIG. 1) which is preferably configured for finding a source. After a topic is identified (301), the database 102 (FIG. 1) is preferably checked for a theme and a source (302). The system searches for an outside source of information (304), if an appropriate source is not found in the internal system resources. The source is preferably returned (303, 305) to the retrieval & identification processor (FIG. 1, 105) for future data mining, analysis and comparison.

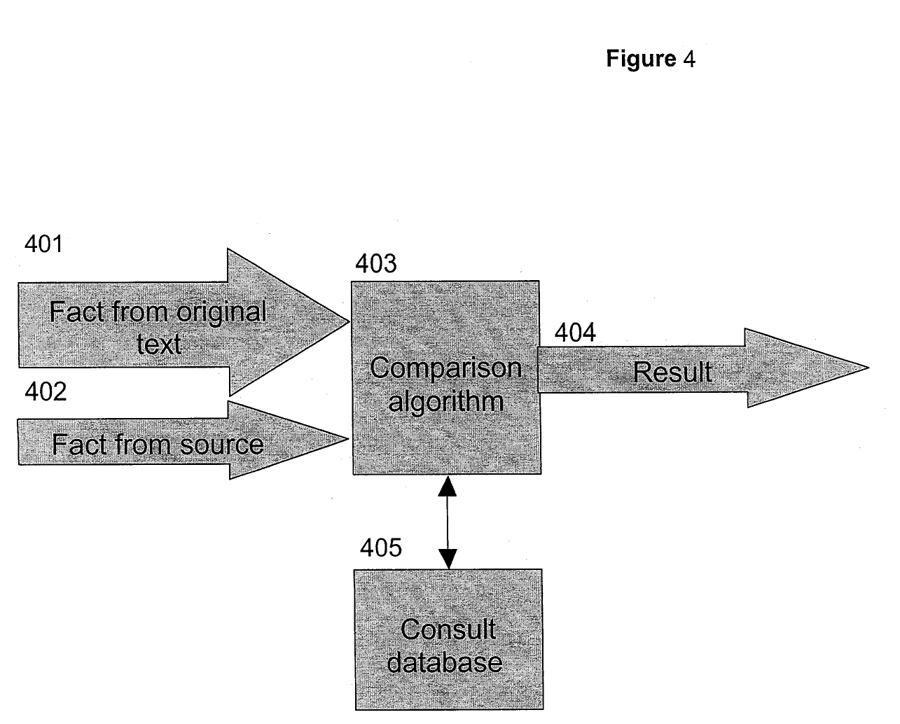

FIG. 4 is a flow diagram illustrating another operational aspect, particularly with regard to origin-source verification processor 112. The origin-source verification processor may preferably utilize methods (403) known in the art encompassing either or both of the comparison of a fact from original text (401) and comparison of a fact from a found source(s) (402) to yield results 404. The system databases 102 & 103 (FIG. 1) may preferably serve as additional media for consulting (405).

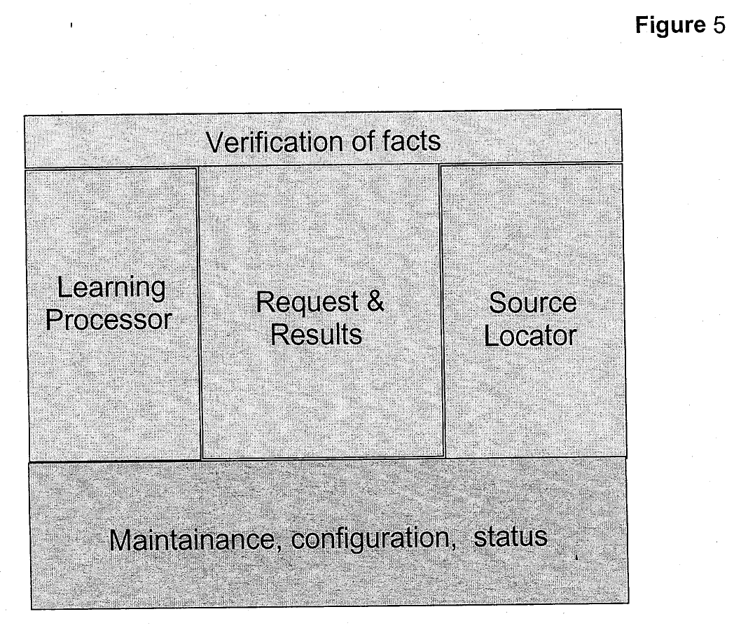

FIG. 5 is a diagram illustrating another operational aspect, particularly with regard to a verification of facts portal (FIG. 1, 104) or, indeed, any other visual presentation form that may be independent or plugged-in. Preferably, the portal allows a customer to submit requests for an individual fact checking, request that the screen document facts, configure themes or topics, and add facts and sources.

It is to be understood that the present invention, in accordance with at least one presently preferred embodiment, includes at least one of a fact-identification arrangement and a fact-verification arrangement, which may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for providing fact verification for a body of text, said system comprising at least one of:
a fact-identification arrangement which automatically identifies at least one subset of the body of text potentially containing a fact-based statement; and
a fact-verification arrangement which is adapted to automatically consult at least one information source towards determining whether at least one fact contained in a fact-based statement is true or false.

2. The system according to claim 1, wherein said system comprises both of: said fact-identification arrangement and said fact-verification arrangement.

3. The system according to claim 2, further comprising a result-presentation arrangement which presents results from at least one of said fact-identification and said fact-verification arrangements.

4. The system according to claim 2, wherein where said fact-verification component is adapted to automatically consult information on the World Wide Web.

5. The system according to claim 2, further comprising an arrangement for customizing a target list of sources to be consulted by said fact-verification arrangement.

6. The system according to claim 5, wherein said customizing arrangement is adapted to customize a target list of sources via the inclusion of at least one database comprising at least one of: topical facts, known false statements, and commonly used facts.

7. The system according to claim 2, wherein said fact-identification arrangement is adapted to employ at least one predetermined component of the body of text towards identifying candidate facts.

8. The system according to claim 7, wherein the at least one predetermined component includes at least one of: proper names, dates, weekday names, subject-specific keywords, names of diseases, quotations, titles, addresses, zip codes, telephone numbers, and geographical names.

9. The system according to claim 3, wherein said result-presentation arrangement is adapted to provide a list of results which includes at least one of: statements of fact that were verified to be true, statements of fact that were found to be false, statements of fact whose truth could not be determined, and an indication of any subset of text that potentially included at least one statement of fact but which could not be adequately processed.

10. A method for deploying computing infrastructure, comprising integrating computer readable code into a computing system, wherein the code in combination with the computing system is capable of performing a method of providing fact verification for a body of text, comprising at least one of the following:
automatically identifying at least one subset of the body of text potentially containing a fact-based statement; and
automatically consulting at least one information source towards determining whether at least one fact contained in a fact-based statement is true or false.

11. The method according to claim 10, wherein said method comprises both of said identifying and consulting steps.

12. The method according to claim 11, further comprising the step of presenting results from at least one of said identifying and consulting steps.

13. The method according to claim 11, wherein where said consulting step comprises automatically consulting information on the World Wide Web.

14. The method according to claim 11, further comprising the step of customizing a target list of sources to be consulted in said consulting step.

15. The method according to claim 14, wherein said customizing step comprises customizing a target list of sources via the inclusion of at least one database comprising at least one of: topical facts, known false statements, and commonly used facts.

16. The method according to claim 11, wherein said identifying step comprises employing at least one predetermined component of the body of text towards identifying candidate facts.

17. The method according to claim 16, wherein the at least one predetermined component includes at least one of: proper names, dates, weekday names, subject-specific keywords, names of diseases, quotations, titles, addresses, zip codes, telephone numbers, and geographical names.

18. The method according to claim 12, wherein said step of presenting results comprises providing a list of results which includes at least one of: statements of fact that were verified to be true, statements of fact that were found to be false, statements of fact whose truth could not be determined, and an indication of any subset of text that potentially included at least one statement of fact but which could not be adequately processed.

19. A program storage device readable by machine, tangibly embodying a program of instructions executable by the machine to perform method steps for providing fact verification for a body of text, said method comprising at least one of the following steps:
automatically identifying at least one subset of the body of text potentially containing a fact-based statement; and
automatically consulting at least one information source towards determining whether at least one fact contained in a fact-based statement is true or false.
